(19) United States
(12) Patent Application Publication
(10) Pub. No.: US 2016/0113250 A1
(43) Pub. Date: Apr. 28, 2016

(54) AERATOR FOR ENHANCING AQUATIC LIFE BY CREATION OF MAGNETIC WATER

(71) Applicant: ONCE INNOVATIONS, INC., Plymouth, MN (US)

(72) Inventor: Zdenko Grajcar, Orono, MN (US)

(21) Appl. No.: 14/895,982

(22) PCT Filed: Jun. 6, 2014
(86) PCT No.: PCT/US2014/041331

§ 371 Date: Dec. 4, 2015

Related U.S. Application Data
(60) Provisional application No. 61/831,749, filed on Jun. 6, 2013.

(51) Int. Cl. A01K 63/04; B01F 3/04

(52) U.S. Cl. CPC A01K 63/042; B01F 3/04773; A01K 63/04; B01F 2003/04872; B01F 2003/04943

(57) ABSTRACT

An aerator having a rotatable shaft that is secured to a magnetic driving element and a plurality of plates positioned in spaced apart relation to the magnetic driving element. Each plate and the magnetic driving element have a plurality of elongated openings about their peripheries to enhance aerodynamics and thus oxygen content within the aerated water. Simultaneously because of the rotation of the magnetic driving element a magnetic field is created in the water providing optimum conditions for the growth of algae and biofloc within the water.

### CROSS-REFERENCE TO RELATED APPLICATIONS

This application claims the benefit of priority to U.S. Provisional Patent Application Serial No. 61/831,749, entitled “Aerator for Enhancing Aquatic Life by Creation of Magnetic Water,” which was filed by Z. Grajcar on Jun. 6, 2013, the entire contents of which are incorporated herein by reference.

### BACKGROUND

This invention relates to aerators. More specifically this invention relates to an aerator designed to create oxygen enriched magnetic water to enhance aquaculture.

In aquaculture there is a new way of growing aquatic life such as shrimp, fish and the like. The idea is to create a closed loop biofloc system. Bioflocs are aggregates of algae, bacteria, protozoans and other particulate matter. Specifically, aquatic life eats from the biofloc and then produces waste in the form of nitrogen that in turn facilitates or fuels the creation of additional biofloc.

Aeration in biofloc systems is necessary to produce not only oxygen that to be used by the aquatic life, but also to ensure suspension of the biofloc allowing the aquatic life to continually feed on the biofloc. In such aquaculture systems the amount of oxygen in the water is constantly monitored. In particular without oxygen aquatic life will die and with the nitrogen being produced in the closed loop systems, if an abundance of nitrogen is present harmful ammonia can be presented in the system. Also, as a result of the suspended biofloc respiration rates are typically high, meaning aerators are typically used to provide additional oxygen into the water. If a sufficient amount of oxygen is not supplied the entire closed loop system can fail.

Aerators have been used for years to increase oxygen levels in aquaculture settings. Typically such aerators have been used in flow through or open loop type settings where water is constantly replaced and algae is seen as a nuisance. In particular in the open loop system external feed is provided to the aquatic life and the forming of biofloc is typically non-existent or prevented.

One example of this type of aerator is shown in U.S. Pat. No. 6,280,078 to Lewis that is incorporated in full herein. The Lewis patent teaches a mixing apparatus that has a central disc driven by a rotating shaft and a plurality of individual spaced apart discs or plates optionally stacked above and/or below the central disc, each with a varying diameter forming frustroconical compartments or cones that receive and accelerate water through the system. In addition each disc has an opening for receiving a fastener therein. As water flows through the aerator enhanced mixing is provided and oxidation enhanced. Still such a system can be detrimental to biofloc systems because the aerator can effectively kill algae.

In closed loop biofloc systems, because the biofloc, consisting of algae is the food source for the aquatic life, if additional algae and thus biofloc can be created, larger amounts of food will be available for the aquatic life. This not only presents larger aquatic life, but in addition increases the yield such a closed loop system can have. Thus, there is a need in the art to provide conditions within the biofloc closed loop system that are favorable to the growth of algae and the biofloc.

The magnetized water phenomenon is well known in the art. As a simple example, when round magnets are placed on the top or bottom of a bottle filled with water and the bottle is flipped, the bottle forms a vortex as a result of the magnetic field. Over the years individuals have found magnetic water to have beneficial properties, including being a superior carrier of minerals through water. As an example, one manner used to increase algae growth in a static tank is to pump the water from the tank through a solenoid and back into the tank. The solenoid creates a magnetic field and thus magnetic water that carries minerals and nutrients to the algae in an efficient manner that causes an increase in the growth of the algae. Still, while effective in growing additional algae in the small environment of a tank, a need in the art exists to use such technology in an outdoor type ecosystem.

Therefore, a principle object of the present invention is to provide and aerator that enhances biofloc growth.

Yet another object of the present invention is to maximize the efficiencies of an aerating device.

These and other objects, feature and advantages shall become apparent from the rest of the specification and claims.

### SUMMARY OF THE INVENTION

An aerator for enhancing aquatic life by creation of magnetic water having a rotatable shaft powered by a power supply. A magnetic driving element having a plurality of elongated openings around its outer periphery is secured to the rotating shaft and a plurality of plates that similarly have a plurality of openings in their outer periphery. The plurality of plates are positioned in spaced relation from the magnetic driving element. By providing the elongated openings in the outer periphery of both the magnetic driving element and plurality of plates, aerodynamics of the aerator are enhanced providing more efficient and stronger aeration, maximizing oxygen content within the mixed water. In addition, the rotation of the magnetic driving element creates a magnetic field within the water and thus magnetizes the water thus providing optimum growing conditions for algae and biofloc.

### BRIEF DESCRIPTION OF THE DRAWINGS

FIG. 1 is a perspective view of an aeration device;

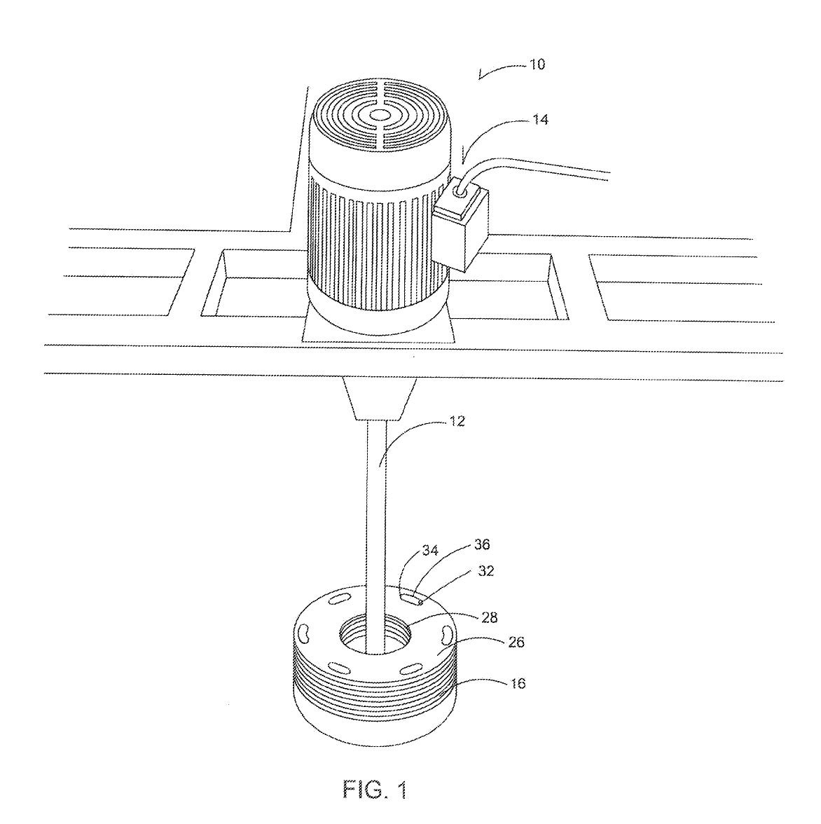

FIG. 2 is a top perspective view of actuating members of an aeration device;

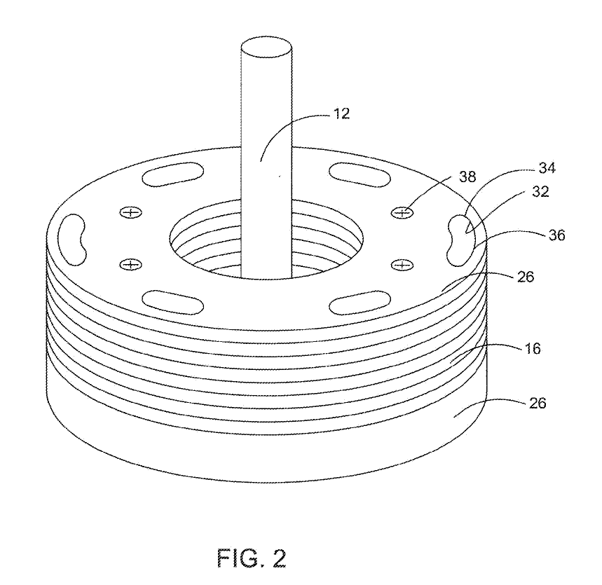

FIG. 3 is a bottom perspective view of actuating members of an aeration device;

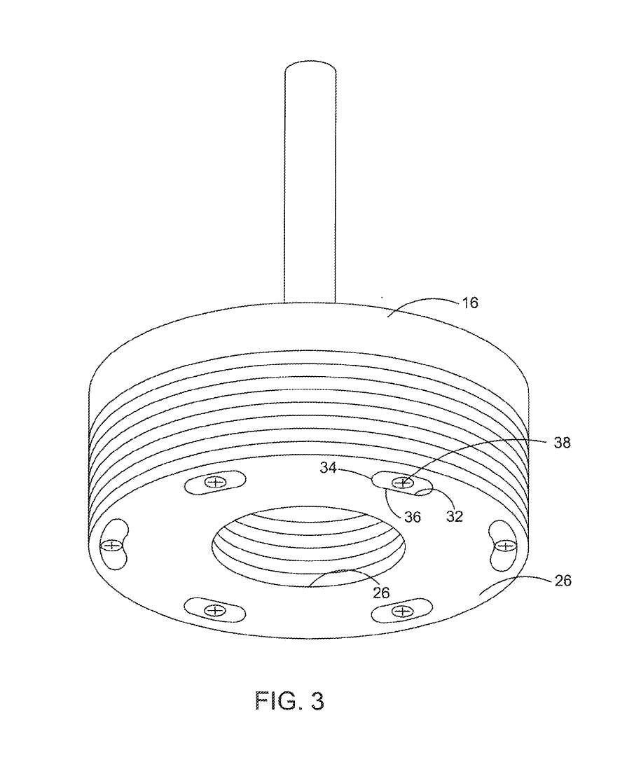

FIG. 4 is a top plan view of a magnetic driving element of an aeration device;

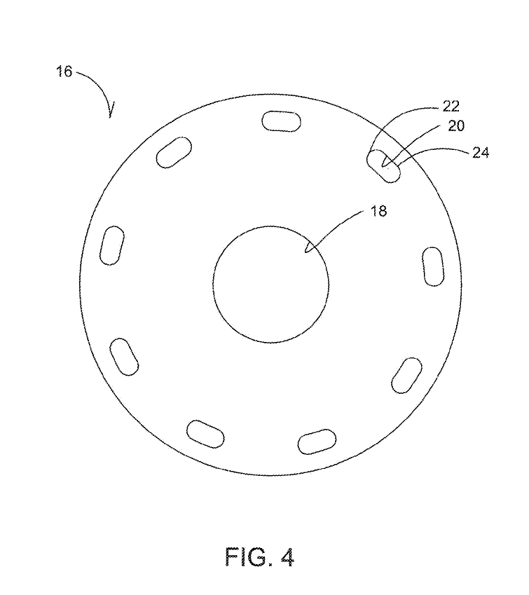

FIG. 5 is a sectional view of actuating members of an aeration device;

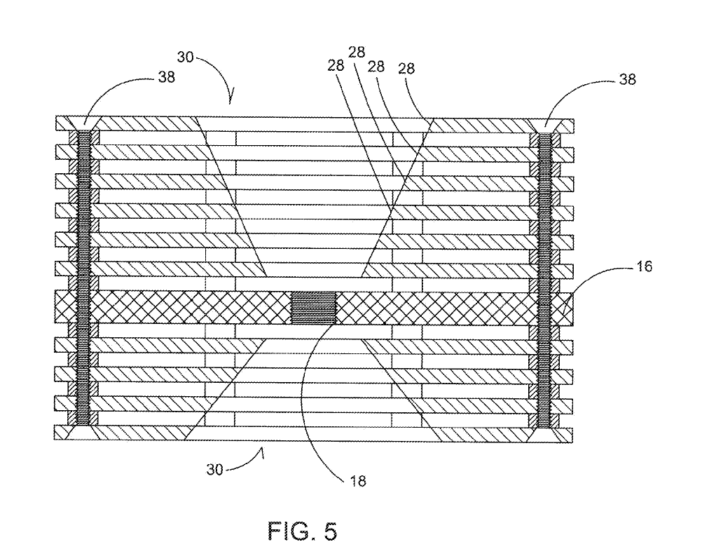

FIG. 6 is a sectional view of actuating member of an aeration device;

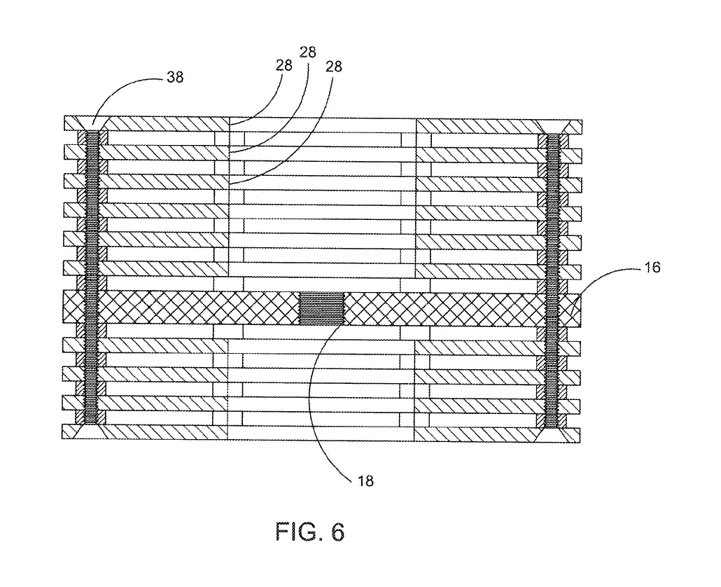

FIG. 7 is a side schematic view of an aeration device; and

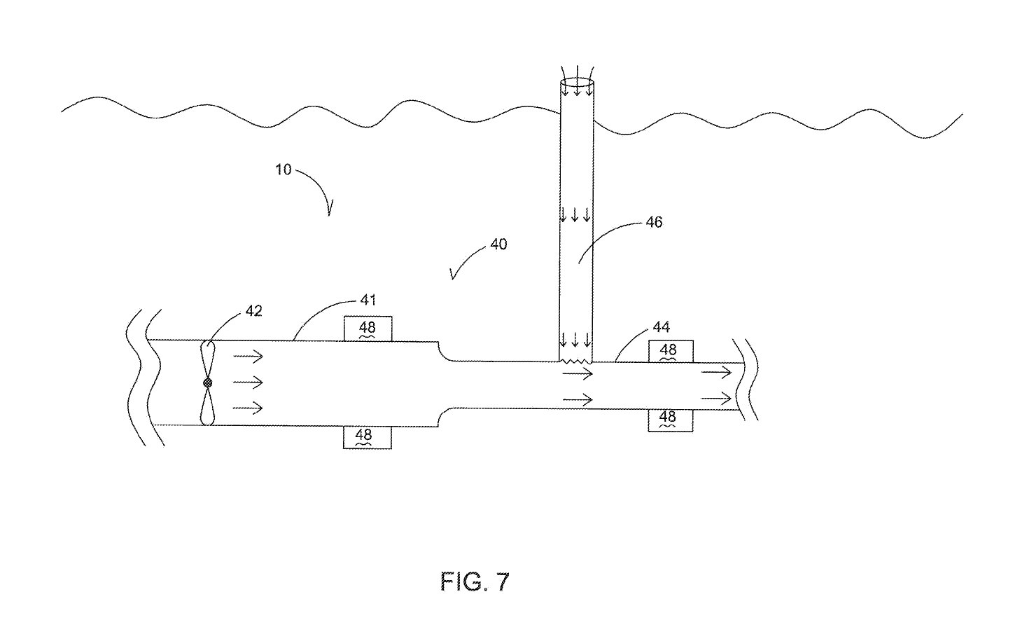

FIG. 8 is a side schematic view of an aeration device.

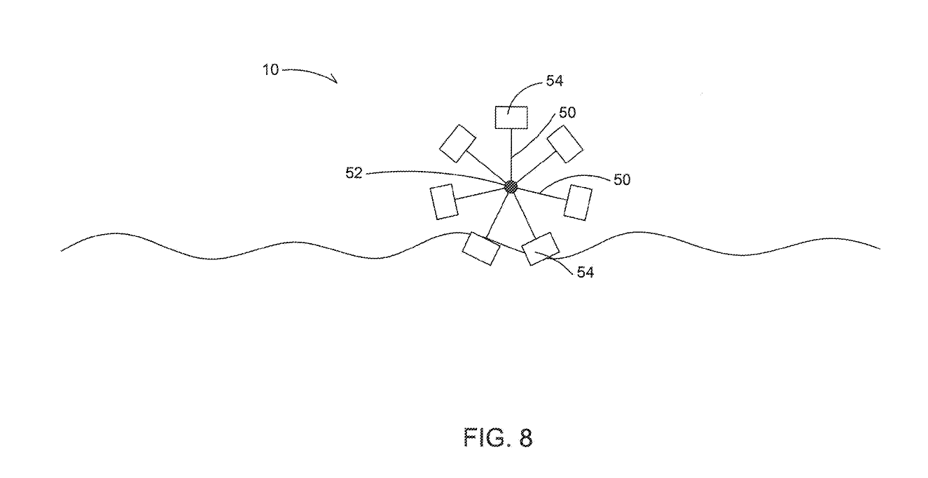

### DETAILED DESCRIPTION OF A PREFERRED EMBODIMENT

An aeration device 10 having a rotatable shaft 12 that is powered by a power supply 14. The rotatable shaft 12 is secured to a magnetic driving disc element 16 that is made of a magnetic material. In one embodiment the magnetic driving disc element 16 is a rare earth magnet and preferably made of neodymium. The magnetic driving disc element 16 has a centrally located opening 18 for receiving and securing the magnetic driving disc element 16 to the rotatable shaft 12. The magnetic driving disc element 16 also has a plurality of elongated openings 20 with rounded ends 22 and an elongated body 24 such that the openings 20 generally have an oval shape. The openings 20 are spaced apart around the periphery of the magnetic driving disc element 16 and preferably are spaced equidistant around the periphery.

A plurality of plates 26 are secured to and positioned in spaced relation from the magnetic driving disc element 16 and one another similar to as is shown in U.S. Pat. No. 6,280,078 to Lewis. Each plate 26 has a central opening 28 that can be of differing diameters in order to form a frustroconical compartment 30 as taught by Lewis, or each diameter can be equal or staggered without falling outside the scope of this invention. Similar to the magnetic driving disc element 16 each plate 26 has a plurality of elongated openings 32 with rounded ends 34 and an elongated body 36 such that the openings 32 generally have an oval shape. The openings 32 are spaced apart around the periphery of each plate 26 and preferably are spaced equidistant around the periphery.

In one embodiment fasteners 38 are disposed through elongated openings 20 of the magnetic driving disc element 16 and elongated openings 32 of the plurality of plates 26 to secure the plates 26 and disc element 16 together such that rotation of the disc element 16 causes rotation of the plates 26. Alternatively the fasteners 38 can be disposed through separate openings within the disc element 16 and plates 26. In particular the elongated openings 20 and 32 of the disc element 16 and plates 26 are aerodynamic and thus of size and shape to facilitate the flow of fluid past the openings 20 and 32 to enhance turbulent flow to maximize aeration and mixing. While the openings 20 and 32 even with the fastener disposed therein will provide improved flow characteristics, when the fastener is removed a greater effect is provided. Thus the center openings 28 of the plates and the peripheral openings 20 and 32 of the plates and disc element 16 can be altered to maximize aeration and mixing within the aeration device 10.

In operation, as the disc element 16 and plates 26 rotate together within water having algae or other aquatic life, the water flows through the aeration device influenced by the openings 20, 28, 32 disposed within the disc element 16 and plates 26 in order to create turbulent flow to mix the water and add oxygen to the water. Simultaneously, the rotation of the magnetic driving disc element 16 creates a magnetic field in order to create magnetic water. The end result is that water coming from the aerator device 10 not only is rich in oxygen, but additionally is magnetic making the water a better carrier of minerals and thus optimizing the living conditions for algae and aquatic life alike within the water. These optimum conditions enhance algae and aquatic life growth, providing more biofloc and thus food source allowing more aquatic life to be healthier, larger and have a higher survival rate. Thus a greater yield of aquatic life results.

In an alternative embodiment the aeration device 10 presents a tubing system 40 having a first tube section 41 with a fluid moving device 42 such as a paddle wheel, impeller or the like that coveys fluid in a first direction toward a second tube section 44. In one embodiment the second tube section 44 has a diameter that is less than the diameter of the first tube section 41. An auxiliary tube section 46 is connected to either the first or second tube sections 41 or 44 and extends at a non-zero angle from the first or second tube sections 41 or 44. The connection between the first or second tube sections 41 or 44 creates a fluid passage between the auxiliary tube section 46 and the first or second tube sections 41 or 44. The auxiliary tube section 46 is sized to extend above the surface of the fluid or preferably water in which the system 40 is disposed. In this manner as the fluid flows from the first tube section 41 to the second tube section 44 oxygen is drawn into the tubing system 40. In this manner a venturi type system is presented.

Magnetic devices 48 are disposed around the first or second tube sections 41 or 44 such that a magnetic field is within the sections 41 or 44 and the water expelled by the tubing system is magnetized. In one embodiment the magnetic devices 48 are provided with an actuator to rotate the magnetic devices 48 about the tube sections 41 or 44. Again, preferably the magnetic devices 48 are rare earth magnets such as neodymium. Thus, oxygen enriched magnetized water flows from the aerator device 10 presenting an optimum output for algae and aquatic life within the ecosystem.

In another embodiment the aerator device is a paddle wheel having a plurality of paddles 50 extending from a center section 52. The paddles 50 are supported in the water by any means, including being attached to floats, having a standard secured into the bottom of the body of water or any other means that presents the paddles within water. When actuated the paddles 50 rotate about the center section 52 to engage and mix water, enhancing the oxygen content therein. Magnets 54 such as rare earth magnets, preferably neodymium are secured to each individual paddle 50, preferably at the end of the paddle opposite the center section 52. As the paddles 50 rotate the magnets 54 in turn rotate creating a magnetic field while also increasing oxygen within the water. Therefore again, an optimum environment for biofloc and in particular algae and aquatic life.

Thus presented are multiple aerator devices 10 that provide an optimum growing environment for aquatic life. The devices 10 enhance the growth of algae through increasing oxygen in the water or fluid and creating a magnetic field through which the water or fluid flows to magnetize the water or fluid providing for optimum biofloc and aquatic life growth increasing health, size and yield with an ecosystem. Therefore all of the stated objectives have been met.

What is claimed:

1. An aerator for enhancing aquatic life by creation of magnetic water comprising:
a rotatable shaft;
a magnetic driving element secured to the rotatable shaft so that rotation of the rotatable shaft rotates the magnetic driving element; and
a plurality of plates secured to and positioned in spaced relation from the magnetic driving element;
wherein as the magnetic driving element and plurality of plates rotate simultaneously to mix water the magnetic driving element creates a magnetic field to create magnetic water.

2. The aerator of claim 1 wherein the magnetic driving element has a plurality of elongated openings spaced apart around the periphery of the magnetic driving element to enhance turbulent flow of fluid past the openings.

3. The aerator of claim 1 wherein the plurality of plates each have a plurality of elongated openings spaced apart around the periphery of each plate to enhance turbulent flow of fluid past the openings.

4. The aerator of claim 1 wherein the magnetic driving element is made from a rare earth magnet.

5. The aerator of claim 1 wherein each of the plurality of plates each having a central opening.

6. The aerator of claim 1 wherein the diameter of the central opening of each of the plurality of plates is equal.

7. An aerator for enhancing aquatic life by creation of magnetic water comprising:
a tubing system having a first tube section and a second tube section extending from the first tube section and wherein the second tube section has a diameter less than the first tube section;
an auxiliary tube section connected to first and second tube sections and extending at a non-zero angle from the first and second tube sections;
a fluid moving device within the first tube section that propels fluid from the first tube section to the second tube section causing air to be drawn through the auxiliary tube section to convey oxygen into the fluid; and
at least one magnetic device disposed about at least one of the first tube section, or the second tube section to magnetize fluid conveyed therethrough.

8. An aerator for enhancing aquatic life by creation of magnetic water comprising:
a plurality of paddles extending from a center section such that the paddles convey and mix the water upon rotation about the center section;
at least one magnet disposed on an end of each paddle opposite the center section; and
wherein as the paddles rotate within the water a magnetic field is created to magnetize the water.
